(19) United States
(12) Patent Application Publication
(10) Pub. No.: US 2012/0029965 A1
(43) Pub. Date: Feb. 2, 2012

(54) SELECTING A PROJECT PORTFOLIO

(76) Inventors: Roger J. Steffen, Cupertino, CA (US); Susan Spence, Cambridge (GB); Christopher Peitz, Windsor, CO (US); David Farrington Ludwig, Austin, TX (US)

(21) Appl. No.: 12/846,696

(22) Filed: Jul. 29, 2010

(51) Int. Cl. G06Q 10/00

(52) U.S. Cl. 705/7.23

(57) ABSTRACT

Disclosed embodiments relate to selecting a project portfolio. A processor may select a project portfolio based on a list of projects and lists of objectives. In one embodiment, a project portfolio is selected from the list of projects based on the degree to which each project portfolio fulfills the lists of objectives. The lists of objectives may be stakeholder objectives.

### BACKGROUND

An organization may have multiple potential projects to complete, but limited resources. For example, an information technology department may receive a list of desired projects from multiple areas of a company. However, the information technology department may have a limited budget and time commitment to devote to suggested projects.

### BRIEF DESCRIPTION OF THE DRAWINGS

In the accompanying drawings, like numerals refer to like components or blocks. The drawings describe example embodiments. The following detailed description references the drawings, wherein:

FIG. 1 is a block diagram illustrating one example of a computing system.

FIG. 2 is a flow chart illustrating one example of a method for selecting a project portfolio.

FIG. 3 is a block diagram illustrating one example of selecting a project portfolio.

FIG. 4 is a flow chart illustrating one example of a method for updating a group of projects based on responses from stakeholders.

FIG. 5 is a block diagram illustrating one example of updating a group of projects based on responses from stakeholders.

### DETAILED DESCRIPTION

An organization may have a large number of requested projects. However, time and budget constraints may limit the number and types of projects that may be completed. As a result, an organization may compile a portfolio of projects that may be completed with the available resources. In some cases, there may be multiple stakeholders where each stakeholder has a preference on the types of projects selected for completion. For example, a chief financial officer may prefer projects that maximize profit and a general counsel may prefer projects that minimize risk. As another example, each department in an organization may prefer projects that benefit that particular department. Projects may be selected based on benefits to the organization as a whole, such as selecting projects providing the biggest financial advantage. However, such a process may result in stakeholders' interests not being fairly represented. A political selection process may result for choosing projects to pursue. For example, a project may be selected based on the importance of the person or department requesting it rather than based on the overall benefit to the entire organization. A political process may result in an inequitable distribution of resources across an organization.

In one embodiment, a portfolio of projects is selected based on an analysis of stakeholder objectives. A group of projects may be selected to efficiently use the available resources in a manner that addresses the objectives of multiple stakeholders. In some implementations, each stakeholder may provide a list of objectives related to the available projects. The objectives in each list may be weighted to indicate their relative importance to a stakeholder. For example, a stakeholder may choose a list of objectives and rank them in order of importance.

An automated system may select multiple options for project portfolios based on the lists of stakeholder objectives. Choosing project portfolios using an automated system that accounts for stakeholder objectives may decrease the likelihood that political motives would alter a more desirable project list. The system may select projects for each of the portfolios by choosing projects likely to fulfill the lists of stakeholder objectives, such as likely to fill a large number of stakeholder objectives or likely to fulfill a particular number or percentage of objectives associated with each stakeholder. In one embodiment, user input is used to determine the type of considerations for selecting the project portfolios. Users may select one of the project portfolio options and complete the projects within that portfolio. Presenting the selected groups of projects may provide a list of projects that may be agreed upon by the stakeholders or may create a starting point to start a conversation between the various stakeholders about the value of competing objectives.

In one embodiment, stakeholders provide feedback on the project portfolio options, and the feedback is used to revise the project portfolio options. For example, each stakeholder may rank the project portfolio options or provide feedback about what is liked or disliked about a project portfolio or a particular project within a project portfolio. The system may use the feedback to create an updated list of project portfolios. In some implementations, multiple rounds of feedback may be performed. The system may use the feedback to converge on a project portfolio that all stakeholders approve. By providing more than one group of projects and allowing for feedback, the automated system may maintain some connection to human aspects of decision making while still using constraints, such as a budget, and quantifiable objectives.

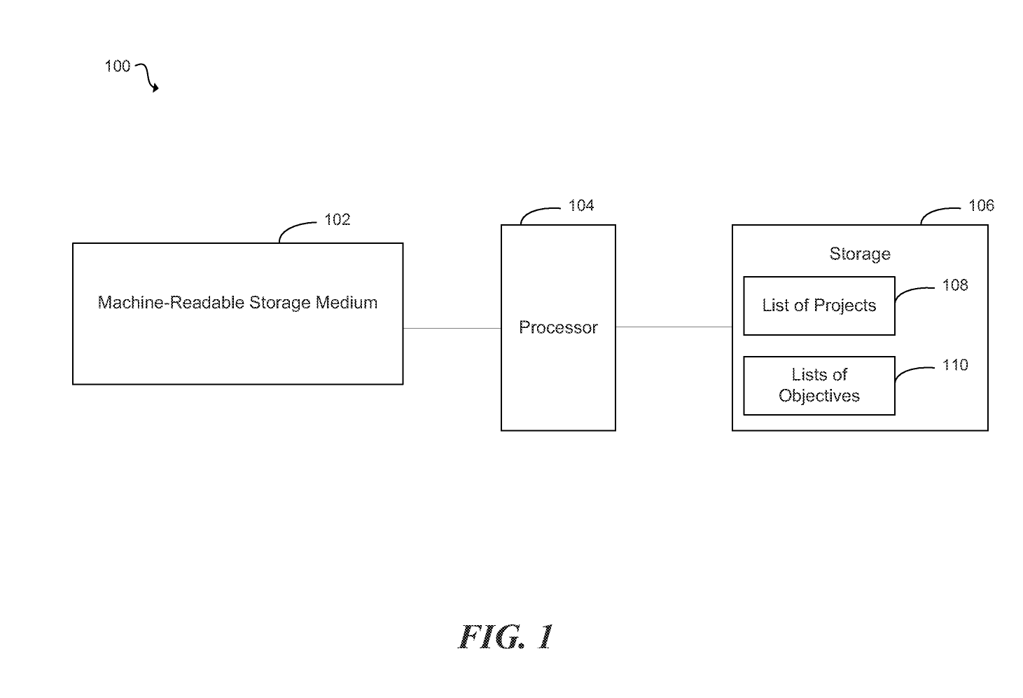

FIG. 1 is a block diagram illustrating one example of a computing system 100. The computing system 100 may include, for example, a machine-readable storage medium 102, a processor 104, and a storage 106.

The storage 106 may be any suitable storage, such as a volatile or non-volatile storage. In some implementations, the storage 106 may be a database that the processor 110 communicates with directly or via a network. The storage 106 may include, for example, a list of projects 108 and lists of objectives 110.

The lists of objectives 110 may include any information related to objectives for projects. In one embodiment, each list of objectives within the lists of objectives 110 is related to a stakeholder. For example, a marketing department may have objectives A, B, and C, and a finance department may have objectives B and D. The objectives of the various stakeholders may be overlapping, unrelated, or mutually exclusive. The stakeholder may be any suitable stakeholder, such as an individual, business unit, department, or region. The objectives included in the lists of objectives 110 may be any suitable objectives. For example, an objective may be to spend under a certain amount in a quarter, to minimize risk, to perform specific projects, or to perform projects associated with a department or region.

The list of projects 108 may include any suitable projects. In some implementations, the list of projects 108 is entered by users that request the entered projects. The list of projects 108 may include a list of current or future projects, such as projects waiting to be completed or projects not yet started. The list of projects 108 may be associated with information related to the types of objectives it may fulfill, such as related information about a cost, department, region, or product associated with each project. For example, the list of projects 108 may include associated information about a cost amount or time amount for each project, and an objective may include a total amount of time or money to be used.

The processor 104 may be any suitable processor. For example, the processor 104 may be one or more central processing units (CPUs), semiconductor-based microprocessors, and/or other devices suitable for retrieval and execution of instructions stored in machine-readable storage medium 102. The processor 104 may fetch, decode, and execute instructions stored in the machine-readable storage medium 102 to implement the functionality described in detail below. As an alternative or in addition to fetching, decoding, and executing instructions, the processor 104 may include one or more integrated circuits (ICs) or other electronic circuits that comprise a plurality of electronic components for performing the functionality described below.

The machine-readable storage medium 102 may be any electronic, magnetic, optical, or other physical storage device that stores executable instructions or other data (e.g., a hard disk drive, random access memory, flash memory, etc.). The machine-readable storage medium 102 may include instructions executable by the processor 104, for example, instructions to access lists of objectives related to stakeholders, instructions to access a list of projects, instructions to choose a portfolio of projects from the list of projects based on the degree to which each project fulfills the lists of objectives, and instructions to output the chosen portfolio of projects.

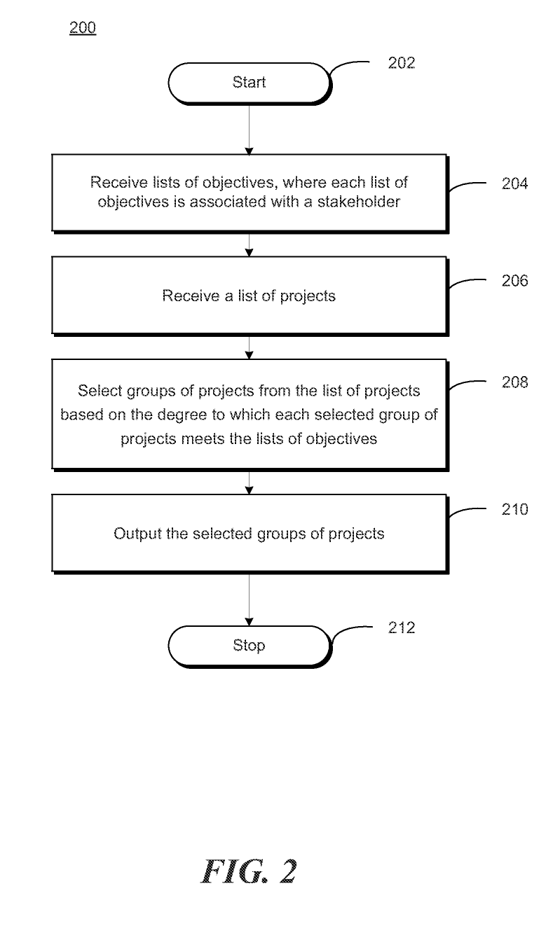

FIG. 2 is a flow chart illustrating one example of method 200 for selecting a project portfolio. Groups of projects may be selected based on constraints, such as a time and budget, by comparing the list of projects 108 to the lists of objectives 110 associated with stakeholders. In one embodiment, the groups of projects are output, for example, to display them to stakeholders.

Beginning at block 202 and moving to block 204, the processor 104, such as by executing instructions stored in the machine-readable storage medium 102, receives the lists of objectives 110, where each list of objectives is associated with a stakeholder. The objectives included in the lists of objectives 110 may be any suitable objectives. For example, the objectives may be to pursue a particular project or group of projects, to complete projects benefiting a particular department, region, or other unit, or to keep the total cost of selected projects below a particular amount.

The lists of objectives 110 may be associated with a stakeholder in any suitable manner. For example, each stakeholder may have a list of objectives associated with it. In one embodiment, the lists of objectives 110 and stakeholder information are stored in the storage 106. A stakeholder may be, for example, a person, unit, region, or other entity. For example, a North America region of an organization may have a list of objectives and an Asia region of an organization may have a list of objectives. In some cases, the stakeholders may overlap. For example, there may be a list associated with a South America region and a list associated with a marketing unit even though there is marketing work performed in the South America region.

The processor 104 may access the lists of objectives 110 in any suitable manner. For example, the processor 104 may retrieve the lists of objectives 110 from a storage, such as the storage 106. The processor 104 may receive the lists of objectives 110 from another application or from an end user. For example, a stakeholder may enter the list of objectives associated with it, or an administrator may enter the lists of objectives associated with each of the stakeholders. In one embodiment, the processor 104 accesses the lists of objectives 110 and stores them in the storage 106 for later retrieval. In one embodiment, the processor 104 also receives information related to the lists of objectives, such as information related to how an objective may be satisfied. For example, an objective for completing projects related to North America may have associated information about which offices are located within North America.

In one embodiment, the objectives in each list of objectives are associated with a weight indicating the importance of the objective relative to the other objectives in the list. For example, a stakeholder may rank its list of objectives in order of importance to the stakeholder. In one embodiment, the processor 104 receives a relative weight associated with each objective. For example, objective A may be weighted as high importance and objectives B and C may be weighted as low importance for a particular stakeholder.

In one embodiment, the processor 104 receives information about the relative importance of one list of objectives compared to another list of objectives. For example, an objective list associated with the CEO of an organization may be considered more important than an objective list associated with an employee, or an objective list associated with a bigger department may be considered more important than the objective list of a smaller department. The processor 104 may receive, for example, an order of importance related to each objective list or a relative weight of importance associated with each objective list.

Continuing to block 206, the processor 104, such as by executing instructions stored in the machine-readable storage medium 102, receives a list of projects, such as the list of projects 108. The projects may include any suitable projects. For example, the projects may include current or future projects. The projects may be related to any suitable area, such as information technology, construction, or staffing.

In some implementations, the list of projects 108 includes a list of projects and information associated with the projects. The list of projects 108 may include information used to determine whether a project fulfills one of the objectives. For example, the list of projects 108 may associate a project with a department it is related to, a region it is related to, the cost, the time involved, or how it relates to another entity.

The processor 104 may access the list of projects 108 in any suitable manner. For example, the processor 104 may retrieve the list of projects 108 from a storage, such as the storage 106. The processor 104 may receive the list of projects 108 from another application or from end users. In one embodiment, a user enters or uploads the list of projects 108 using a user interface. The processor 104 may receive the list of projects 108 and store them in the storage 106 for later retrieval.

Proceeding to block 208, the processor 104, such as by executing instructions stored in the machine-readable storage medium 102, selects groups of projects from the list of projects 108 based on the degree to which each selected group of projects meets the lists of objectives 110. For example, group A may include projects 1, 2, and 3, group B may include projects 2, 3, and 5, and group C may include projects 6, 7, and 8. Each chosen group of projects may be a potential group of projects that may be pursued while still fitting within the system constraints, such as time and budget constraints. The processor 104 may select any number of groups of projects. In one embodiment, the processor 104 receives a setting, such as a setting from user input, indicating the number of groups of projects to select. This may allow users to determine whether they would like more or less choices of project-groups presented to them.

The processor 104 may choose the groups of projects in any suitable manner. For example, the processor 104 may compare the list of projects 108 to the lists of objectives 110 to determine how to fulfill as many of the objectives from the lists of objectives 110 as possible given the constraints or how to fulfill objectives such that a similar number of objectives from each stakeholder list are fulfilled. In one embodiment, the processor 104 receives a setting indicating the manner to be used to determine project groups. In one embodiment, the processor 104 uses a different selection manner for each of the groups of projects that it selects. For example, a first group of projects may be selected based on fulfilling as many of the objectives from the lists of objectives 110 as possible given the constraints, and a second group of projects may be selected based on fulfilling at least one objective related to each stakeholder list. In some implementations, the processor 104 may place more value on objectives or projects that are desirable by more stakeholders and less on those that are conflicting amongst stakeholders. For example, if project A meets an objective associated with many stakeholders, it may be more likely to be selected for the project portfolio options.

The processor 104 may use an optimization technique, such as an evolutionary algorithm, to select groups of projects. In some implementations, the processor 104 applies a genetic algorithm to the list of projects 108 and the lists of objectives 110 to determine the project portfolios. The processor 104 may assign each of the projects from the list of projects 108 a value, such as a 1 or 0, to reflect whether a project is part of a selected project portfolio. Initially, the processor 104 may generate many, such as 1000, random groups of projects as potential project portfolios. The processor 104 may rank the project groups based on their fulfillment of the lists of objectives 110. The processor 104 may use the previous round of project groups to select the next generation of project groups. The processor 104 may select the top ranked project groups from a previous round, such as the top 50 project groups, to determine a new generation of project groups. Each round may produce multiple project groups, such as 1000 project groups. After several rounds, the top ranked project groups, such as the top three, may be output. In some cases, the number output is determined by a setting, such as a setting provided by a user.

In some implementations, the processor 104 focuses on an objective or list of objectives for each round of selection. In some cases, several rounds of selection are performed for each objective or list of objectives. For example, the processor 104 may perform five rounds with the same objective before moving to the next objective. An input value may indicate the frequency or order to go through the lists of objectives 110. In some cases, analyzing another objective may undo some of the optimization associated with the previous objective. However, outputting multiple project groups may increase the likelihood that one of the groups presents a preferred group of projects.

In one embodiment, the processor 104 considers weights associated with objectives in a list. For example, an objective list may have weights such as rankings or ratings associated with them. The processor 104 may attempt to select projects that fulfill objectives that have greater weights associated with them.

In one embodiment, the processor 104 selects project portfolios based on the characteristics of the stakeholder associated with a list of objectives. For example, the processor 104 may select groups of projects based on the importance or role of a stakeholder associated with a list of objectives. The processor 104 may receive weights or rankings associated with each stakeholder or list of objectives indicating how the list associated with the stakeholder should be weighed against other lists. For example, a CEO stakeholder list of objectives may be weighted greater than an employee stakeholder list of objectives.

In some implementations, a list of objectives associated with an administrator stakeholder is valued higher relative to other stakeholders' objectives. For example, stakeholders may choose objectives that are most beneficial to them, and an administrator stakeholder may choose objectives tailored to the organization as a whole, such as an objective to distribute projects across multiple regions. In one embodiment, the lists of objectives are weighted based on other factors in addition to the stakeholder associated with them.

The processor 104 may determine a time period of execution associated with the projects selected for a group of projects. The processor 104 may associate a quarter or other time period with a project. For example, the processor 104 may determine that a project may not be completed during a particular quarter due to time or budget constraints, but the processor 104 may determine that the project may be pursued if the start date is delayed. The processor 104 may receive a setting related to each project within the list of projects 108 indicating whether a project may be delayed.

In one embodiment, the processor 104 assigns a value reflecting the start date of a project to each of the projects within the selected groups of projects. The start date may be used as the processor 104 performs multiple rounds of selection of groups of projects.

Moving to block 210, the processor 104, such as by executing instructions stored in the machine-readable storage medium 102 outputs the selected groups of projects. For example, the processor 104 may store the selected groups of projects in a storage, such as the storage 106. In one embodiment, the processor 104 may format the selected groups of projects for display on an electronic device associated with the processor 104 or another electronic device. For example, information about the selected projects may be displayed on a user computer networked to the processor 104. The processor 104 may display the selected groups of projects and information about the relevant objectives related to each of the projects in each of the groups. This may allow stakeholders to better engage in a dialogue about competing objectives. In some cases, the groups of projects will converge upon the lists of objectives 110 such that a group of projects satisfies each of the stakeholders. Even if the groups of projects presented do not satisfy each of the stakeholders, the differences between the stakeholders' objectives and the impracticality of satisfying each list of objectives may be exposed. The method 200 then moves to block 212 to end.

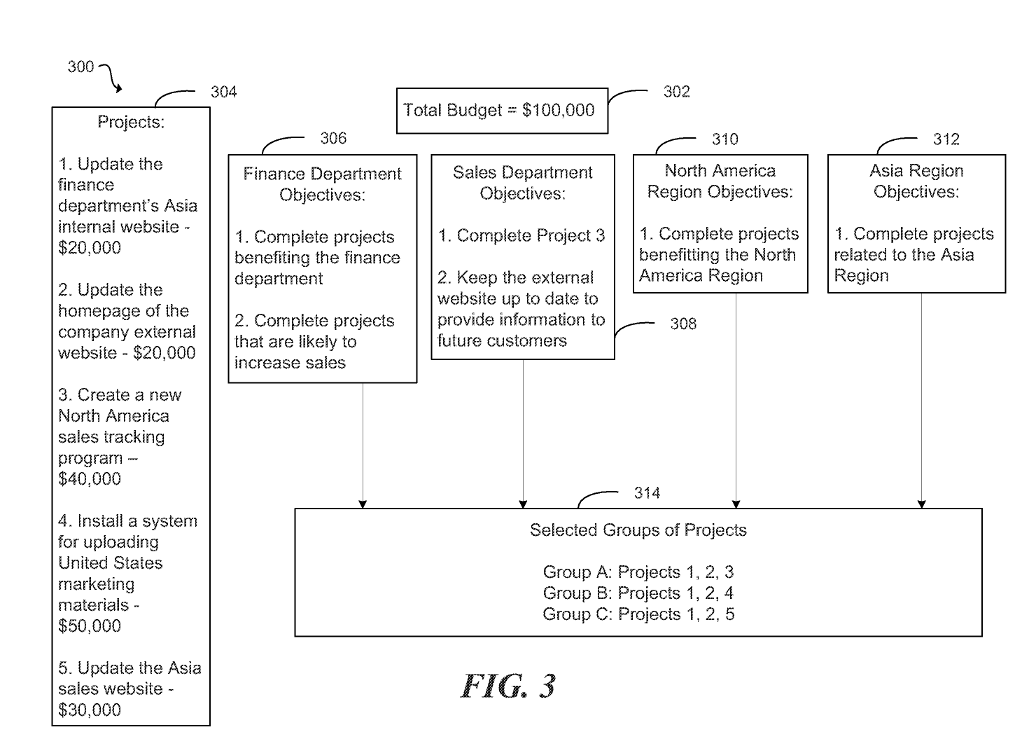

FIG. 3 is a block diagram 300 illustrating one example of selecting, a project portfolio. Block 302 shows that the budget for projects is $100,000. Block 304 lists five potential projects, including updating the finance department's internal Asia website, updating the homepage of the company's external website, creating a North America sales tracking program, installing a system for uploading United States marketing materials, and updating the Asia sales website. Block 306 lists the finance department's objectives, block 308 lists the sales department's objectives, block 310 lists the North America region's objectives, and block 312 lists the Asia region's objectives. Multiple lists of projects may be chosen from the list of projects shown in block 304 based on the objectives of the finance department, sales department, North America region, and Asia region.

The finance department and sales department stakeholders have differing objectives. The finance department's objectives are shown in block 306. The objectives include projects benefitting the finance department and projects likely to increase sales. Based on these objectives, the finance department would likely want projects 1, 2, and 5 to be completed. The sales department's objectives shown in block 308 shows that the sales department would like project 3 completed and would like the external website to be kept up to date. Based on these objectives, the sales department would likely want project 2 for updating the company homepage and project 3 for creating a North America sales tracking system to be completed.

A North America and Asia region may each have objectives also. The North America region's objective to complete projects benefitting the North America region is shown in block 310. The objective suggests that the North America region would select project 2 for updating the company homepage, project 3 for creating a North America sales tracking system, and project 4 for installing a system for uploading United States marking materials. The Asia region's objectives shown in block 312 indicate that the Asia region would like projects benefitting the Asia region to be completed. The objectives indicate that the Asia region would like for projects 1, 2, and 5 to be completed.

Based on the $100,000 budget, not all of the projects meeting the objectives of the different departments and regions may be completed. Block 314 shows three possible project portfolios. The groups of selected projects may be created by comparing the list of objectives to the list of projects. Multiple groups are shown to provide stakeholders multiple choices for how to compromise. For example, Group A shown in block 316 suggests projects 1, 2, and 3. Group B shown in block 318 suggests projects 1, 2, and 4 and Group C shown in block 320 suggests projects 1, 2, and 5. Stakeholders may view the lists of projects and determine which they would like to choose. In some cases, the multiple lists may be used to start a dialogue between stakeholders. In some cases, a stakeholder may choose to change its list of objectives in view of conflicts with other stakeholders evident by the selected groups of projects. If the stakeholders change their objectives, the selection process may be performed again based on updated objectives.

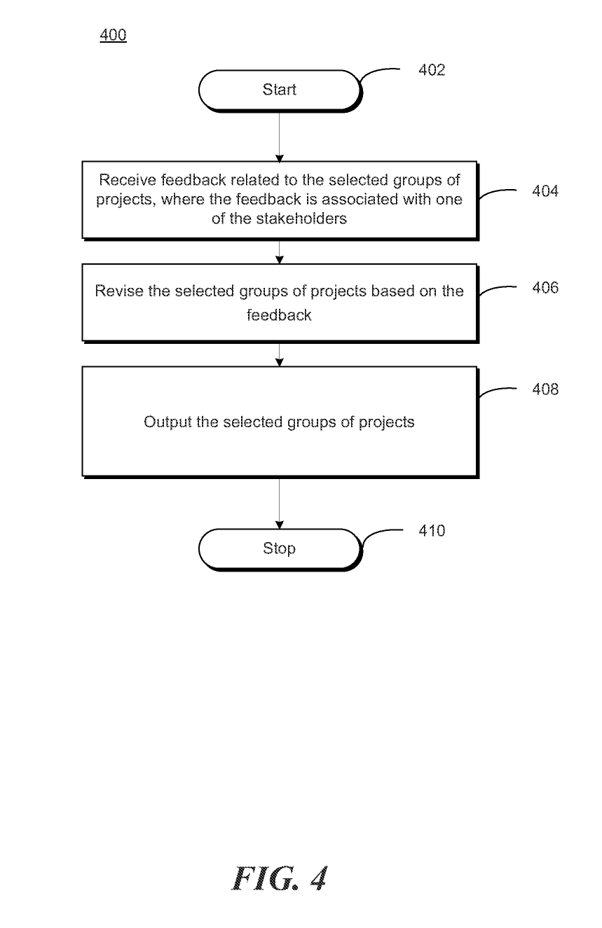

FIG. 4 is a flow chart illustrating one example of a method 400 for updating a group of projects based on responses from stakeholders. In one embodiment, the processor 104 receives feedback related to the selected groups of projects. For example, each stakeholder may provide feedback indicating which of the groups of projects the stakeholder liked or disliked. The processor 104 may use the feedback to select updated groups of projects. Feedback may be useful for adding a human element to the project selection process. Mathematically preferred projects selected by the processor 104 may in some cases not satisfy stakeholders, and feedback may be used to provide additional information to the processor 104 about the preferences of the stakeholders beyond the lists of objectives 110.

Beginning at block 402 and moving to block 404, the processor 104, such as by executing instructions stored in the machine-readable storage medium 102, receives feedback related to the selected groups of projects, where the feedback is associated with one of the stakeholders. For example, multiple stakeholders may provide feedback of their opinion of the groups of projects selected by the processor 104. Each stakeholder may have a different view of the selected groups of projects. Stakeholders may provide feedback related to the various versions of compromise shown in the groups of projects to indicate which group or groups the stakeholder views as better tailored to the stakeholder's objectives.

The processor 104 may receive the feedback in any suitable manner. The processor 104 may receive the feedback from a user, such as through a user interface. For example, the feedback may be entered by the particular stakeholder, an administrator, or other user. In one embodiment, the processor 104 retrieves the feedback from the storage 106. The processor 104 may store the feedback in the storage 106 and retrieve it at a later time.

The feedback may be any suitable feedback. The feedback may be, for example, related to whether the stakeholder's list of objectives is fulfilled by each of the groups of projects. The feedback may be a ranking or weight associated with the individual projects in the project portfolios. The feedback may indicate an assessment of one of the selected groups of projects, such as reasons that a list of projects or a particular project is preferred. For example, the feedback may indicate that one of the groups of projects is not preferred because it includes project 3 or does not include enough projects related to area X. In some cases, feedback may be received from a subset of stakeholders and other stakeholders may choose not to provide feedback.

The feedback may indicate a preference or ranking of the selected project portfolios. For example, each stakeholder may rank the groups of projects in the order in which the groups of projects best fulfill the stakeholder's objectives. In some cases, the original lists of objectives may not contain all of a stakeholder's views, and the lists of selected projects may show different options of compromise. If all of a stakeholder's objectives are not met by one of the groups of projects, a stakeholder may determine which it views as the best scenario of the ones presented by the processor 104.

Proceeding to block 404, the processor 104, such as by executing instructions stored in the machine-readable storage medium 102, revises the selected groups of projects based on the feedback. The processor 104 may revise the selected projects in any suitable manner. For example, the processor 104 may apply an evolutionary algorithm to further refine the selected project portfolios. For example, the processor 104 may start with the project portfolio preferred by the most stakeholders and continue to create new versions of project portfolios based on the lists of objectives 110 and the feedback.

Continuing to block 406, the processor 104, such as by executing instructions stored in the machine-readable storage medium 102, outputs the selected groups of projects. For example, the processor 104 may format the selected groups of projects for display to a user. The processor 104 may send the selected groups of projects to a user electronic device via a network. In one embodiment, the processor 104 stores the selected groups of projects in the storage 106. The method 400 then continues to block 408 and ends.

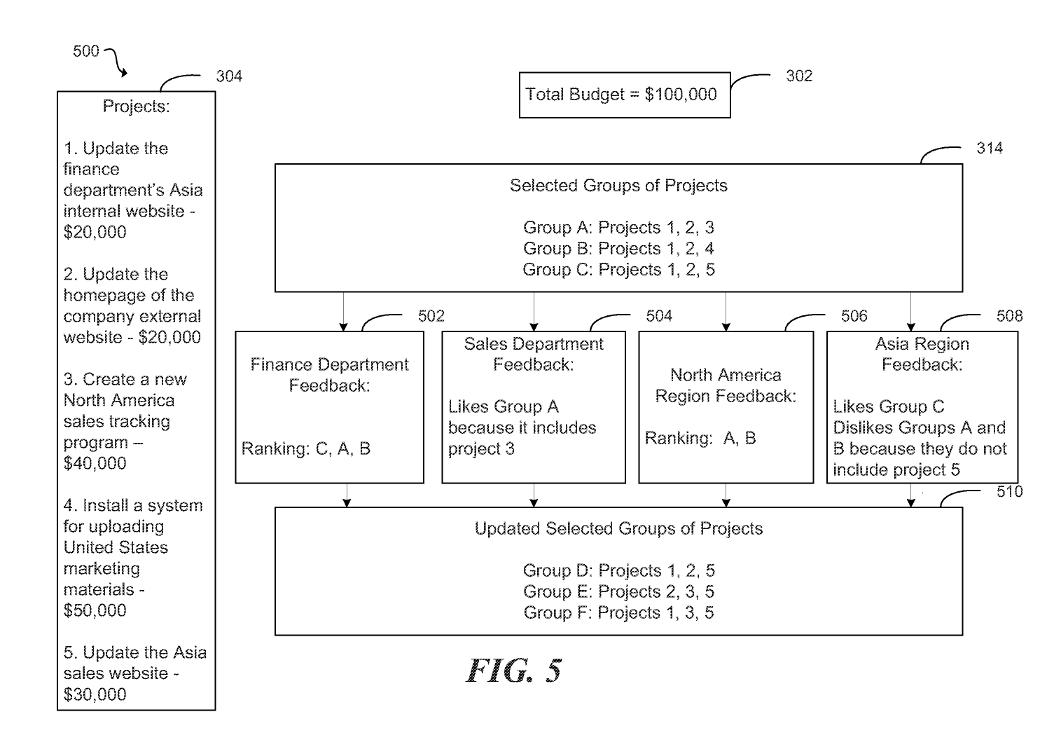

FIG. 5 is a block diagram 500 illustrating one example of updating a group of projects based on responses from stakeholders. Block diagram 500 shows the selected groups of projects from FIG. 3 in block 314, the list of projects from FIG. 3 in block 310, and the total budget from FIG. 3 in block 302. Blocks 502, 504, 506, and 508 show stakeholder feedback to the selected groups of projects shown in block 314. For example, block 502 shows feedback from the finance department indicating it ranks the groups in order of C, A, B. Based on the finance department's objectives shown in FIG. 3 block 306, the finance department would like to see projects 1, 2, and 5 completed, which are shown in Group C, the group it ranked first. Group A includes projects 1, 2, and 3, and group B includes projects 1, 2, and 4. After looking at the options, the finance department may decide that it sees more value in project 3 than in project 4. The finance department may rank Group A higher than group B to reflect this.

Block 504 shows feedback from the sales department. Based on the objectives for the sales department in block 308 in FIG. 3, it is likely that the sales department would want projects 2 and 3 completed. The feedback indicates that the sales department likes Group A because it includes project 3. The feedback may indicate that the sales department sees project 3 as very important and project 2 as less important.

Block 506 shows feedback from the North America region. The objectives in block 310 of FIG. 3 suggest that the North America region would like for projects 2, 3, and 4 to be completed. The feedback indicates that the North America region prefers Group A, including projects 1, 2, and 3, over Group B, which includes projects 1, 2, and 4. This may indicate that the North America region prefers project 3 over project 4 if both projects may not be completed.

Block 508 shows feedback from the Asia region. The Asia region's objectives shown in block 312 of FIG. 3 suggest that the Asia region would like projects 1, 2, and 5 completed. The feedback in FIG. 508 shows that the Asia region likes Group A including projects 1, 2, and 5 and dislikes Groups B and C because they do not include project 5.

Block 510 shows updated selected groups of projects based on the feedback from the stakeholders. For example, Group D may include projects 1, 2, and 5 because half of the stakeholders, the finance department and the Asia region, seem to like the projects shown in the previous Group C including projects 1, 2, and 5. Group E includes projects 2, 3, and 5. This may because the finance department preferred Group A, including project 3, to Group B, including project 4, the Asia region indicated that it would like project 5 completed, the sales department indicated that it would like project 3 completed, and the North America region showed that it preferred a group including projects 1, 2, and 3. Group F includes projects 1, 3, and 5. It may be selected for similar reasons to Group E, and it may be shown to see whether some of the stakeholders that prefer projects 1, 2, and 5 would prefer project 1 over project 2. Additional rounds of feedback could be performed on the updated selected groups of projects shown in block 510.

An automated system for selecting projects based on stakeholder objectives may create a more equitable and transparent system. In some cases, it may remove some of the politics behind project portfolio selection. Such a system may present a group of projects that can be agreed upon by stakeholders or start a dialogue between stakeholders on how to resolve competing interests.

1. A computing system for selecting a project portfolio, comprising:
a storage to store:
a list of projects;
lists of objectives, wherein each list of objectives is associated with a stakeholder; and
a processor to select groups of projects from the list of projects based on the degree to which each selected group of projects meets the lists of objectives.

2. The computing system of claim 1, wherein the processor further:
receives feedback related to the selected groups of projects, wherein the feedback is associated with a stakeholder; and
updates the selected groups of projects based on the feedback.

3. The computing system of claim 1, wherein the received feedback comprises a ranking of the selected groups of projects.

4. The computing system of claim 1, wherein the processor further associates a time period for execution with each of the projects within the selected group of projects.

5. The computing system of claim 1, wherein selecting groups of projects is further based on characteristics of the stakeholder associated with each list of objectives.

6. A method for selecting a project portfolio, comprising:
receiving, by a processor, lists of objectives, wherein each list of objectives is associated with a stakeholder;
receiving, by the processor, a list of projects;
selecting, by the processor, groups of projects from the list of projects based on the degree to which each selected group of projects meets the lists of objectives; and
outputting, by the processor, the selected groups of projects.

7. The method of claim 6, wherein selecting groups of projects is further based on characteristics of the stakeholder associated with each list of objectives.

8. The method of claim 6, further comprising:
receiving, by the processor, feedback related to the selected groups of projects, wherein the feedback is associated with one of the stakeholders;
revising, by the processor, the selected groups of projects based on the feedback; and
outputting, by the processor, the selected groups of projects.

9. The method of claim 8, wherein the feedback related to the selected groups of projects comprises a ranking of the groups of projects.

10. The method of claim 8, wherein the feedback related to the selected groups of projects comprises an assessment of one of the selected groups of projects.

11. A machine-readable storage medium encoded with instructions executable by a processor for selecting a project portfolio, the machine-readable medium comprising instructions to:
access lists of objectives, wherein each list of objectives is related to a stakeholder;
access a list of projects;
choose portfolios of projects from the list of projects based on the degree to which each chosen portfolio of projects fulfills the lists of objectives; and
output the chosen portfolio of projects.

12. The machine-readable storage medium of claim 11, wherein choosing portfolios of projects is further based on characteristics of the stakeholder related to each list of objectives.

13. The machine-readable storage medium of claim 11, wherein the objectives in each list of objectives are associated with a weight indicating their importance relative to the other objectives in the list and wherein choosing portfolios of projects is further based on the weight associated with each objective in the lists of objectives.

14. The machine-readable storage medium of claim 11, further comprising instructions to:
receive a response related to the chosen portfolio of projects, wherein the response is associated with one of the stakeholders;
update the chosen portfolio of projects based on the response; and
output the chosen portfolio of projects.

15. The machine-readable storage medium of claim 14, wherein the response related to the chosen portfolio of projects comprises a ranking of the chosen portfolio of projects.
